(19) United States
(12) Patent Application Publication
(10) Pub. No.: US 2024/0403735 A1
(43) Pub. Date: Dec. 5, 2024

(54) Multi-Transportation-Type Comparison of Carbon Footprints

(71) Applicant: Peter G. Khoury, San Francisco, CA (US)

(72) Inventor: Peter G. Khoury, San Francisco, CA (US)

(21) Appl. No.: 18/806,661

(22) Filed: Aug. 15, 2024

Related U.S. Application Data
(63) Continuation-in-part of application No. 17/866,232, filed on Jul. 15, 2022, now abandoned.
(60) Provisional application No. 63/223,059, filed on Jul. 18, 2021.

(51) Int. Cl. G06Q 10/02; G06Q 30/018; G06Q 50/40

(52) U.S. Cl. CPC G06Q 10/025; G06Q 30/018; G06Q 50/40

(57) ABSTRACT

An electronic device that provides recommendation information is described. During operation, the electronic device may obtain itinerary information associated with an individual. Then, the electronic device may determine environmental factors associated with the itinerary information. Moreover, the electronic device may dynamically compute carbon footprints of multiple types of transportation based at least in part on the itinerary information and the environmental factors. For example, a given carbon footprint of a given type of transportation may include an incremental carbon footprint associated with the individual and a total carbon footprint of the given type of transportation. Next, the electronic device may provide recommendation information including the multiple types of transportation and the computed associated carbon footprints.

### CROSS REFERENCE TO RELATED APPLICATIONS

This application is a Continuation-in-Part of U.S. patent application Ser. No. 17/866,232, “Multi-Transportation-Type Comparison of Carbon Footprints,” filed on Jul. 15, 2022, by Peter G. Khoury, et al., which claims priority under 35 U.S.C. 119 (e) to: U.S. Provisional Application Ser. No. 63/223,059, “Simplified Route Planning and Travel Booking Including Consideration of Environmental Impact,” filed on Jul. 18, 2021, by Peter G. Khoury, et al., the contents of both of which are herein incorporated by reference.

### FIELD

The described embodiments relate to comparing the carbon footprint associated with multiple different types of transportation based on dynamic environmental factors.

### BACKGROUND

Itinerary choices when traveling can be complex decisions for individuals to make. Individuals and companies making travel and itinerary decisions usually weigh many different factors and considerations before arriving at what they consider to be the best choice. Some of the factors individuals might consider are expense, time of travel, duration of travel, mode of travel, and the provider.

Recently more and more individuals have become aware of the environmental impacts of their actions and have been taking steps to lower those impacts. Emissions from travel can be highly impactful on the environment adding significant amounts of CO2 and other greenhouse gases to the atmosphere. As one example an individual who wants to reduce the impact of their travel on the environment may want to know the amount of greenhouse gases that might be attributed to various itineraries under consideration. And so now as climate change becomes more and more of a concern some travelers may want to balance and consider environmental impact of their itinerary along with all of the other factors listed above. An itinerary or travel decision which was already complicated prior to the consideration of the environment gets more complicated.

Additionally an individual's intuition of the environmental impacts may not match with more careful analysis. Making the right choice for the environment can't be boiled down to simple rules of thumb which would make itinerary and travel decisions easier. The environmental analysis is often more complicated than a simple slogan like “always fly direct,” or “always drive and don't fly.” There are a number of scenarios where simple rules fail and an individual's intuition might lead them astray in their assessment of the environmental impact of itineraries.

Furthermore assessment of the environmental impact may not be as straight-forward as some of the other factors like expense. Attribution of an amount of global warming potential to an individual's particular itinerary choice can be a subtle calculation with many facets. Estimating the attribution prior to travel when the individual is comparing several different itineraries during the booking process is even more complicated because the estimation must predict certain input factors not currently known.

Environmentally conscious travelers may want timely information that estimates the environmental impact of various itineraries at the time of booking. They might want to be able to balance these impacts against the other more typical factors that impact the convenience of itineraries. Many eco-conscious travelers would want the environment impact attributed in a way that is fair and accurate to both their personal responsibility and to the earth and its ecosystems.

### SUMMARY

An electronic device that provides recommendation information is described. This electronic device includes: an interface circuit, a processor, and memory storing program instructions. During operation, the electronic device obtains itinerary information associated with an individual. Then, the electronic device determines environmental factors associated with the itinerary information. Moreover, the electronic device dynamically computes carbon footprints of multiple types of transportation based at least in part on the itinerary information and the environmental factors. Next, the electronic device provides the recommendation information including the multiple types of transportation and the computed associated carbon footprints.

Note that the electronic device may include a computer system (which may include one or more computers at one or more locations), and the obtaining may include receiving the itinerary information from a second electronic device and the providing may include providing the recommendation information addressed to a third electronic device. In some embodiments, the second electronic device and the third electronic device are different.

Moreover, the itinerary information may include: a departure location and a destination location; a number of travelers; and/or a desired priority for completing at least a portion of an itinerary specified by the itinerary information.

Furthermore, the multiple types of transportation may include different types of transportation vehicles. For example, the different types of transportation vehicles may include two or more of: an airplane, an automobile, a type of mass transit, or a bicycle.

Additionally, the environmental factors may include: available capacity on a given type of transportation (such as available seats on an airplane), weather conditions along at least a portion of an itinerary specified by the itinerary information (such as rain or snow), or traffic conditions along at least a second portion of the itinerary

In some embodiments, the multiple types of transportation may include an airplane and the weather conditions may include a path and a strength of a wind at an altitude of the airplane along at least a portion of the itinerary (such as the jet stream at a cruising altitude of the airplane).

Moreover, the environmental factors may include financial costs or incentives associated with one or more of the multiple types of transportation.

Furthermore, a given carbon footprint of a given type of transportation may include an incremental carbon footprint associated with the individual and a total carbon footprint of the given type of transportation.

Another embodiment provides the second electronic device or the third electronic device.

Another embodiment provides a computer-readable storage medium for use with the electronic device, the second electronic device or the third electronic device. When executed by the electronic device, the second electronic device or the third electronic device, this computer-readable storage medium causes the electronic device, the second electronic device or the third electronic device to perform at least some of the aforementioned operations or counterparts to at least some of the aforementioned operations.

Another embodiment provides a method, which may be performed by the electronic device, the second electronic device or the third electronic device. This method includes at least some of the aforementioned operations or counterparts to at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for providing recommendation information using an electronic device in FIG. 1 in accordance with an embodiment of the present disclosure.

FIG. 3 is a drawing illustrating an example of communication among electronic devices in FIG. 1 in accordance with an embodiment of the present disclosure.

FIG. 4 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device that provides recommendation information is described. During operation, the electronic device may obtain itinerary information associated with an individual. Then, the electronic device may determine environmental factors associated with the itinerary information. Moreover, the electronic device may dynamically compute carbon footprints of multiple types of transportation based at least in part on the itinerary information and the environmental factors. For example, a given carbon footprint of a given type of transportation may include an incremental carbon footprint associated with the individual and a total carbon footprint of the given type of transportation. Next, the electronic device may provide recommendation information including the multiple types of transportation and the computed associated carbon footprints.

By providing the recommendation information, the recommendation techniques may provide transparency about the environmental costs associated with the types of transportation alternatives available to the individual. Moreover, because the environmental factors that impact the different types of transportation are complicated and time-variant, the recommendation techniques may allow the individual to make informed decisions. Notably, the recommendation techniques may allow the individual to behave in a more environmentally responsible or friendly manner, while also efficiently achieving the transportation objectives, such as completing an itinerary in a desired amount of time. Consequently, the recommendation techniques may help the individual be a responsible world citizen without an adverse impact on their quality of life.

In the discussion that follows, electronic devices, computers and/or servers (which may be local or remotely located from each other) may communicate packets or frames in accordance with a wired communication protocol and/or a wireless communication protocol. The wireless communication protocol may include: a wireless communication protocol that is compatible with an Institute of Electrical and Electronics Engineers (IEEE) 802.11 standard (which is sometimes referred to as ‘Wi-Fi®,’ from the Wi-Fi Alliance of Austin, Texas), Bluetooth, Bluetooth low energy, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, the wired communication protocol may include a wired communication protocol that is compatible with an IEEE 802.3 standard (which is sometimes referred to as ‘Ethernet’), e.g., an Ethernet II standard. However, a wide variety of communication protocols may be used. In the discussion that follows, Wi-Fi and Ethernet are used as illustrative examples.

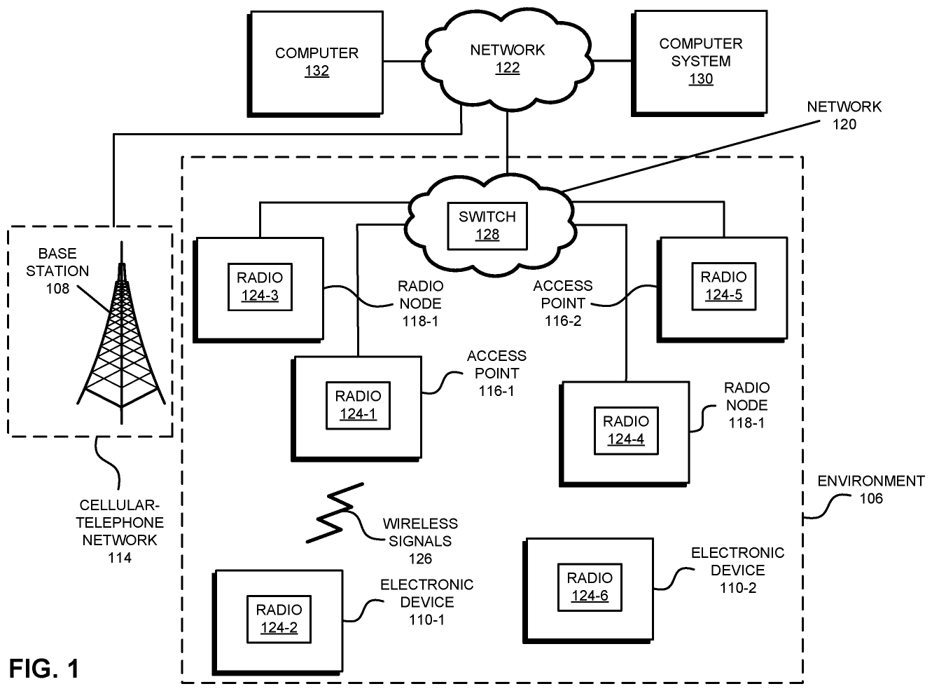

We now describe some embodiments of the recommendation techniques. FIG. 1 presents a block diagram illustrating an example of communication with electronic devices 110 (such as a cellular telephone, a portable electronic device, or another type of electronic device, etc.). Moreover, electronic devices 110 may optionally communicate via a cellular-telephone network 114 (which may include a base station 108), one or more access points 116 (which may communicate using Wi-Fi) in a wireless local area network (WLAN) and/or radio node 118 (which may communicate using LTE or a cellular-telephone data communication protocol) in a small-scale network (such as a small cell). For example, radio node 118 may include: an Evolved Node B (eNodeB), a Universal Mobile Telecommunications System (UMTS) NodeB and radio network controller (RNC), a New Radio (NR) gNB or gNodeB (which communicates with a network k with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio node 118 may be included in one or more networks, such as: a WLAN, a small cell, a local area network (LAN) and/or a cellular-telephone network. In some embodiments, access points 116 may include a physical access point and/or a virtual access point that is implemented in software in an environment of an electronic device or a computer.

Furthermore, electronic devices 110 may optionally communicate with computer system 130 (which may include one or more computers or servers, and which may be implemented locally or remotely) using a wired communication protocol (such as Ethernet) via network 120 and/or 122. Note that networks 120 and 122 may be the same or different networks. For example, networks 120 and/or 122 may be a LAN, an intra-net or the Internet. In some embodiments, the wired communication protocol may include a secured connection over transmission control protocol/Internet protocol (TCP/IP) using hypertext transfer protocol secure (HTTPS). Additionally, in some embodiments, network 120 may include one or more routers and/or switches (such as switch 128).

One or more of electronic devices 110 (such as electronic device 110-1) and/or computer system 130 may implement at least some of the operations in the recommendation techniques. Notably, as described further below, a given one of electronic devices 110 and/or computer system 130 may dynamically compute the carbon footprints associated with different types of transportation at a given time and/or may provide the recommendation information.

As described further below with reference to FIG. 11, base station 108, electronic devices 110, access points 116, radio node 118, switch 128, computer system 130 and/or computer system 132 may include subsystems, such as a networking subsystem, a memory subsystem and a processor subsystem. In addition, electronic devices 110, access points 116 and radio node 118 may include radios 124 in the networking subsystems. More generally, electronic devices 110, access points 116 and radio node 118 can include (or can be included within) any electronic devices with the networking subsystems that enable electronic devices 110, access points 116 and radio node 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, base station 108, electronic devices 110, access points 116, radio node 118 and/or computer system 130 may wired or wirelessly communicate while: transmitting access requests and receiving access responses on wired or wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio node 118 and electronic devices 110. For example, radio 124-1 in access point 116-1 may transmit information (such as one or more packets or frames) using wireless signals 126. These wireless signals are received by radio 124-2 in electronic device 110-1. This may allow access point 116-1 to communicate information to other access points 116 and/or electronic devices 110-1. Note that wireless signals 126 may convey one or more packets or frames.

In the described embodiments, processing a packet or a frame in one or more electronic devices in electronic devices 110, access points 116, radio node 118 and/or computer system 130 may include: receiving the wireless or electrical signals with the packet or the frame; decoding/extracting the packet or the frame from the received wireless or electrical signals to acquire the packet or the frame; and processing the packet or the frame to determine information contained in the payload of the packet or the frame.

Note that the wired and/or wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHZ, 2.4 GHz, 5 GHZ, 6 GHz, 60 GHz, the Citizens Broadband Radio Spectrum or CBRS (e.g., a frequency band near 3.5 GHZ), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

While FIG. 1 illustrates computer system 130 at a particular location, in other embodiments at least a portion of computer system 130 is implemented at more than one location. Thus, in some embodiments, computer system 130 is implemented in a centralized manner, while in other embodiments at least a portion of computer system 130 is implemented in a distributed manner.

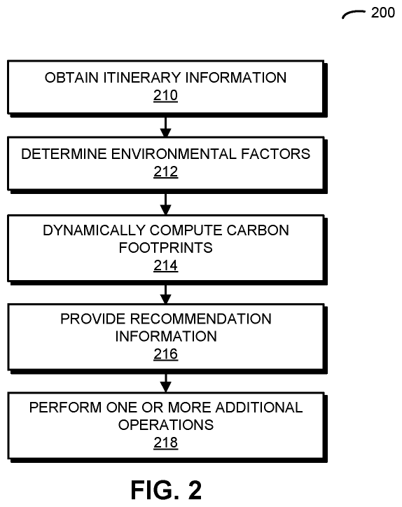

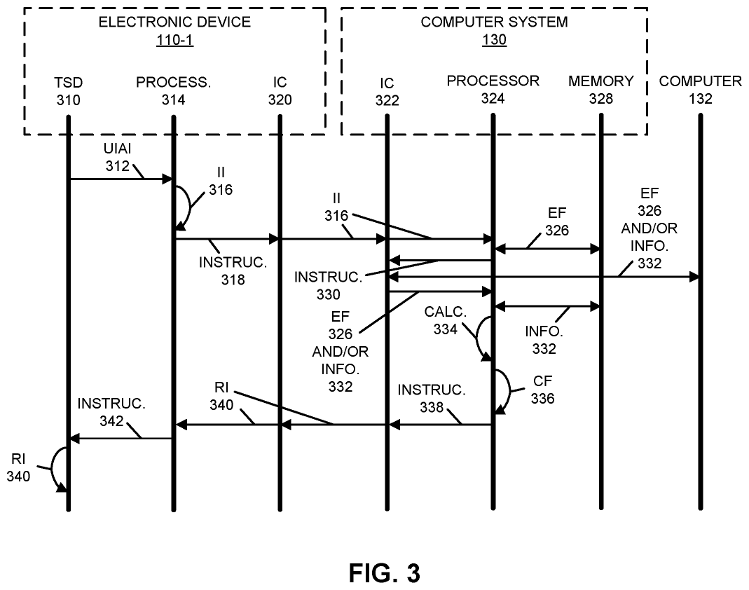

As discussed previously, individuals travelling may want to travel in a more eco-conscious way and may want to consider their environmental impact when choosing itineraries. A recommendation engine helping individuals choose suitable itineraries might need to estimate CO2 equivalent emissions for various itinerary options. To calculate these estimates the recommendation engine will probably need information about the individual(s) itinerary. Moreover, as described further below with reference to FIGS. 2-3, in order to address these challenges, electronic devices 110 and/or computer system 130 may perform the recommendation techniques. Notably, an individual using electronic device 110-1 may provide itinerary information to computer system 130. This itinerary information may include: origin airport or origin address, destination airport or destination address, number of people traveling, desired class of travel, desired arrival and/or departure time, desired duration of journey, ideal duration of a layover.

For some trips the individual using electronic device 110-1 may provide personal information to computer system 130. This personal information may include equipment available (eg does the individual own a bike), level of fitness (ie how fast and far an individual might walk or bike), level of stamina (eg whether an individual would be willing to bike in the rain), how fast the individual drives and how many rest stops they take. In an alternative embodiment electronic device 110-1 and/or computer system 130 might infer some of the above information through the actions that an individual does or does not take. For example does an individual choose to bike when it is raining. Or if the itinerary is being tracked then an individual's actual pace and stamina could be used in place of an individual's self-estimate. An individual's actual driving habits could be used in place of a user's self reported driving habits.

After receiving the itinerary information, computer system 130 may determine or access additional information, such as one or more environmental factors, based at least in part on the itinerary information. For example, the environmental factors may include: aircraft loading, weather (including either current, near term predictions or historical weather patterns), historical chances of delays, vehicle types, aircraft types and engines, actual or predicted freight loads on aircraft or other transport, the likelihood of flight cancellation as a function of the number of passengers on that flight. Note that the additional information may be accessed in memory in computer system 130 and/or remotely in computer system 132. In some embodiments, a given environmental factor may be determined by the historical average passenger loads for a particular route. The historical passenger averages may be categorized or compensated for the day of the week and or by holiday. A specific estimate may be generated from a broad loading trend over many weeks or months with a weekly fluctuation added to the broad trend. Additionally the recommendation system might correlate the chance of delay with the historical pattern of thunderstorm activity or snowstorms. The recommendation system might then look at the historical chances of having a disruptive event during the course of the itinerary.

Then, computer system 130 may dynamically compute the carbon footprint associated with multiple different types of transportation based at least in part on the itinerary information, the environmental factors and/or personal information. As an example the recommendation engine might compare an itinerary consisting of a non-stop flight between the origin and destination with an itinerary consisting of a flight into a nearby airport and a subsequent drive to the destination. The emissions of the air routes in both itineraries would be calculated similarly but in the case of the second itinerary we would include the emissions from the driving leg. The emissions estimate of the driving leg would account for the amount of traffic predicted during the itinerary. For example a driving leg that followed on from a flight arriving in the late afternoon at rush hour would have more vehicle emissions that a driving leg completed in the late evening when traffic is much less likely to be bad.

Then, computer system 130 may dynamically compute the carbon footprint associated with single type of transportation based at least in part on the environmental factors and the itinerary information. Consider that we have knowledge of the origin and destination cities, the details of the aircraft that flies a non-stop route between the two and an estimate of the expected number of passengers on the flight on the day of travel. A straight-forward emissions attribution could start with an estimate of the number of passengers flying on that particular flight. It might add the amount of fuel burned for the aircraft flying empty plus the weight of the passengers and their luggage. The estimation would then calculate the amount of CO2_e produced by the fuel used and add in high altitude effects that might increase the global warming potential of those emissions. Those total emissions would be divided by the estimated number of passengers to predict the amount of emissions that could be attributed to a single passenger on the flight.

A more sophisticated calculation would estimate the amount of freight transported on the flight in addition to the estimated passengers and their luggage. The emissions contribution from the freight would be subtracted off from the total and the remaining emissions would be divided equally amongst the estimated number of passengers.

Another potential calculation might begin with an environmental factor estimate that flights are consolidated when they are less than ½ full. (Ie if an airline has more than one flight covering a particular route it won't fly any aircraft at less than ½ capacity.) If this was the case, then the first group of passengers that fill the aircraft to ½ capacity are responsible for the aircraft's empty flight and fuel burn because the aircraft wouldn't have departed without them. The attribution of emissions to these passengers would be total emissions produced by a ½ full flight divided by the number of this status of passenger. Additional passengers above the ½ full mark would only be attributed the marginal emissions cost of the flight. (ie for these passengers we wouldn't attribute any of the emissions cost of the empty aircraft to them. We would only attribute the emissions from the additional jet fuel burned to transport their weight and the weight of their luggage to the destination.)

Then, computer system 130 may dynamically compute an itinerary recommendation based at least in part on the environmental factors, the itinerary information, and personal information. For example consider a user making a last minute regional trip. Among the possible itineraries is one option to drive directly and another option to take public transit and bike. If the weather was dry, the user of the service might typically prefer the public transit/bike option, but the recommendation engine connected to local weather forecasting observes that rain is predicted to coincide with the public transit itinerary and therefore boosts the driving recommendation and suppresses the public transit/bike option.

Next, computer system 130 may provide the recommendation information to electronic device 110-1. The recommendation information may include or specify the multiple types of transportation and the computed associated carbon footprints.

After receiving the recommendation information, electronic device 110-1 may present the recommendation information to the individual in a user interface, such as on a display. Alternatively or additionally, electronic device 110-1 may present the recommendation information using other sensory outputs associated with electronic device 110-1, such as sound from speakers, using a voice-generation engine, etc.

The recommendation engine might present different itinerary recommendations in list form. Each item in the list might be chosen to be substantially different from the others. For example we might include in the list one option that is the cheapest, one option that has the least emissions, one option that is shortest, one option that leaves early in the day, one option that leaves late in the day. The individual could choose one single option and either book the ticket or start the journey. Or if they aren't satisfied with any of the options they might then choose multiple options in the list that are most appealing and the system would search for a number of compromise routes that trade off the extremes of the initial routes presented. This process could repeat with a user either selecting an individual option or choosing multiple options and seeking a compromise. Through this process the user could hone in on the best option for themselves.

In another embodiment of the presentation of recommendations, the user might be presented with a scatter plot. Each itinerary might be represented by a colored dot placed within a box or a triangle. The edges of the box or the vertices of the triangle might represent extremes of a certain characteristic of the itineraries. For example one edge or vertex might represent the cheapest itineraries. Another edge or vertex might represent itineraries that are best for the environment. The dot representing a particular itinerary would be placed in the region according to its attributes. The user could hover over or touch a dot to examine the specifics of the itinerary. This way they could quickly skim through the options. Since this method of display only visualizes a few of the itineraries attributes the display of the recommendations could pivot the current display from one set of variables to a different set of variables. For example the initial display might show price and CO2_e as the most visible tradeoffs, but the user could switch up the display to show departure time and itinerary duration.

Part of the challenge of this section is that I'm flipping back and forth between flight booking and public transportation/mixed mode offerings.

Based at least in part on the recommendation information, the individual may be able to make informed decisions about their travel plans with good situational awareness about the time-variant environmental impact of their decision.

While the preceding discussion illustrated the recommendation techniques as being performed by computer system 130, in other embodiments at least some of the operations in the recommendation techniques may be performed by electronic device 110-1. For example, at least some of the operations in the recommendation techniques may be performed by an application that is installed on electronic device 110-1 and that executes in an environment (such as an operating system) of electronic device 110-1. Alternatively, in some embodiments, at least some of the operations in the recommendation techniques may be performed by a browser or a browser plug-in executing in the environment of electronic device 110-1.

In some embodiments, the dynamic computations performed in the recommendation techniques may be performed using a pretrained analysis model that is trained using a machine-learning technique (such as a supervised learning technique, an unsupervised learning technique, e.g., a clustering technique, and/or a neural network) and a training dataset. For example, the pretrained analysis model may include a classifier or a regression model that was trained using: a support vector machine technique, a classification and regression tree technique, logistic regression, LASSO, linear regression, a neural network technique (such as a convolutional neural network technique, an autoencoder neural network or another type of neural network technique) and/or another linear or nonlinear supervised-learning technique. Note that computer system 130 may dynamically retrain the analysis model based at least in part on updates to the training dataset, and then may optionally provide an updated analysis model to electronic devices 110.

In these ways, the recommendation techniques may provide transparency about the environmental costs associated with the types of transportation alternatives available to the individual. Therefore, the recommendation techniques may allow the individual to make informed transportation decisions that can reduce the environmental impact of their transportation decisions. Moreover, the collective behaviors of multiple individuals may drive changes in the carbon impact or footprint of different types of transportation.

We now describe embodiments of the method. FIG. 2 presents a flow diagram illustrating an example of a method 200 for providing recommendation information, which may be performed by a computer system (such as computer system 130 in FIG. 1) and, more generally, an electronic device (such as electronic device 110-1 in FIG. 1). During operation, the electronic device may obtain itinerary information (operation 210) associated with an individual. Then, the electronic device may determine environmental factors (operation 212) associated with the itinerary information. Moreover, the electronic device may dynamically compute carbon footprints (operation 214) of multiple types of transportation based at least in part on the itinerary information and the environmental factors. Next, the electronic device may provide the recommendation information (operation 216) including the multiple types of transportation and the computed associated carbon footprints.

In some embodiments, the electronic device may optionally perform one or more additional operations (operation 218). For example, the electronic device may include a computer system (which may include one or more computers at one or more locations), and the obtaining (operation 210 may include receiving the itinerary information from a second electronic device and the providing (operation 216) may include providing the recommendation information addressed to a third electronic device. In some embodiments, the second electronic device and the third electronic device are different.

Moreover, the itinerary information may include: a departure location and a destination location; a number of travelers; and/or a desired priority for completing at least a portion of an itinerary specified by the itinerary information.

Furthermore, the multiple types of transportation may include different types of transportation vehicles. For example, the different types of transportation vehicles may include two or more of: an airplane, an automobile, a type of mass transit, or a bicycle.

Additionally, the environmental factors may include: available capacity on a given type of transportation (such as available seats on an airplane), weather conditions along at least a portion of an itinerary specified by the itinerary information (such as rain or snow), or traffic conditions along at least a second portion of the itinerary

In some embodiments, the multiple types of transportation may include an airplane and the weather conditions may include a path and a strength of a wind at an altitude of the airplane along at least a portion of the itinerary (such as the jet stream at a cruising altitude of the airplane).

Moreover, the environmental factors may include financial costs or incentives associated with one or more of the multiple types of transportation.

Furthermore, a given carbon footprint of a given type of transportation may include an incremental carbon footprint associated with the individual and a total carbon footprint of the given type of transportation.

In some embodiments of method 200, there may be additional or fewer operations. Furthermore, the order of the operations may be changed, and/or two or more operations may be combined into a single operation.

Embodiments of the recommendation techniques are further illustrated in FIG. 3, which presents a drawing illustrating an example of communication among components in electronic device 110-1 and computer system 130. In FIG. 3, an individual using electronic device 110-1 may provide itinerary information (II) 316. For example, the individual may interact with a user interface on a touch-sensitive display (TSD) 310 in electronic device 110-1. The result user-interface activity information (UIAI) 312 that is provided to processor 314 in electronic device 110-1 may specify or correspond to itinerary information 316, which is determined by processor 314. After determining itinerary information 316, processor 314 may instruct 318 interface circuit 320 in electronic device 110-1 to provide itinerary information 316 to computer system 130 (e.g., in one or more packets or frames).

Itinerary information 316 may be received by interface circuit 322 in computer system 130, which provides itinerary information 316 to processor 324 in computer system 130. Based at least in part on itinerary information 316, processor 324 may determine associated environmental factors (EF) 326. For example, processor 324 may access environmental factors 326 in memory 328 in computer system 130. Alternatively or additionally, processor 324 may instruct 330 interface circuit 322 to obtain one or more of environmental factors 326 from computer system 132. In some embodiments, processor 324 may calculate 334 a given environmental factor based at least in part on information 332 accessed in memory 328 or obtained from computer system 132.

Next, processor 324 may dynamically compute carbon footprints (CF) 336 of multiple types of transportation based at least in part on itinerary information 316 and environmental factors 326. Furthermore, processor 324 may instruct 338 interface circuit 322 to provide recommendation information (RI) 340 to electronic device 110-1. Note that recommendation information 340 may include the multiple types of transportation and the computed associated carbon footprints 336.

After receiving recommendation information 340, interface circuit 320 may provide recommendation information 340 to processor 314, which instruct 342 touch-sensitive display 310 to present or display recommendation information 340, e.g., to the individual.

While FIG. 3 illustrates communication between components using unidirectional or bidirectional communication with lines having single arrows or double arrows, in general the communication in a given operation in this figure may involve unidirectional or bidirectional communication.

We now further describe the recommendation techniques ***include/integrate the material from the provisional here.***

Recent years have been the hottest recorded globally. In many parts of the country and the world the weather has become so extreme that people now understand that they need to make changes in their own personal lives to limit their own climate impact. Unfortunately, it is often difficult for people to know the true impact of their own decisions on the climate. Travel is the most easily quantified and oftentimes the most impactful of people's personal activity. The tool described below allows users to bring excellent analytics to their own personal travel choices.

Users need real-time, best-estimate information about environmental impact when making travel plans. Users need this information presented in a way that gets them from point A to point B while balancing their own needs with the needs of the environment. Routing and mode options are incredibly complicated without adding environmental factors. The techniques described below propose to help users combine their options with their own unique circumstances to arrive at the right modes and itinerary for a particular journey.

A user wanting to go from one place to another would enter their starting point and their destination. They may be planning a future trip across the country, in which case they would enter a future date. They may be planning a trip across town, in which case the user would enter a time of day. Or they may be trying to plan a trip for right now.

The user interface (some examples of which are shown in the sections below) would present the user with a variety of options. The options could be ranked by duration, cost, environmental impact, departure time, and/or arrival time. However, we expect that the user would most appreciate a user interface that allows them to choose options in between the extreme top ranked choices in each category.

The system could provide the user with single mode of travel options (e.g., just bike, just take commuter rail, just drive). However, we expect that the system would be most beneficial if it provided multi-modal itineraries as options.

Let's combine the ideas in the previous two paragraphs in an example. Let's say a user wanted to get across the SF Bay to their friend's house in the Oakland hills. The most environmentally friendly option may be to take BART (rail) and then transfer to a bus or walk. But this might take too long. The shortest option might be to drive, but that would release a lot of CO2. They are looking for an itinerary that helps save the bulk of the emissions while completing the journey in a reasonable amount of time. In this hypothetical scenario, the system could suggest taking Bart and then a car-share service (such as Lyft) up into the Oakland hills. Bart saves the bulk of emissions across the Bay and Lyft gets them through the last leg of their journey quickly.

Let's make this example even more creative. If the user knew that the car-share vehicle had a bike rack, they could take Bart across the bay, take their bike on the car-share up the hills (so that they didn't get sweaty). Then, when their visit was over, they could easily bike down the hills to Bart and take Bart home. This would save an additional ride share and so would be even better from an environmental point of view and involves many modes of transportation and constraints.

Another example of itinerary planning involves cross-country flights. Flying uses a lot of energy and every leg uses up significant amounts. While the shortest flights use the least amount of fuel, they are also the least efficient flights. Perhaps a user is trying to get across the country, but there is only one high-cost non-stop flight between the endpoints and the flight is at an inconvenient time. This flight would appear at the top of the environmental rankings, but wouldn't be desirable for the user. Other flights may have another flight leg, which is a disadvantage both for the environmental impact and for the duration of the journey. A perfectly reasonable alternative would be to fly non-stop into a nearby airport and drive the short distance to the final destination. This situation exists between San Francisco International Airport and Raleigh-Durham International Airport for which the only non-stop flight is a red-eye, which is undesirable to many users. But there are many non-stop flights from San Francisco International Airport to Charlotte and it is only a 2 hr and 30 min drive from Charlotte to Raleigh, which means that the duration of the full multi-modal journey of flight plus rental car is on par with a multi-stop itinerary.

The following are variables that we may need to consider in routing and itinerary planning.

Endpoints: We may need to know the endpoints of the journey and any additional stops.

Number of travelers: The environmental impact of different modes of travel varies considerably with the number of people travelling together. Cars become more efficient as they carry more people.

Date and time of travel: Someone may want to enter a range of dates and/or times for travel.

Constraints: Does the user have any deadline and/or price constraints for this particular journey.

Vehicle particulars: What vehicle(s) does the user own. From this we can deduce the rough fuel efficiency and the number of passengers the vehicle can accommodate. Does the user's vehicle have a roof rack?

Personal data such as the following could improve the recommendations:

Walking information: How much does the user like to walk? How fast do they walk? How far would they walk? What sort of neighborhoods would they walk through and what times of day? Is the user willing to walk in bad weather?

Biking information: Does the user ever bike to travel? Do they have their own bike? Is their bike an electric bike? What sorts of streets would they ride on (e.g., busy or empty, with or without a bike lane)? Is the user willing to bike in bad weather?

Alternative transport: Do they own a scooter, electric skateboard, or other mobility device (either electric or otherwise)? Would they be willing to rent an electric scooter?

Cost sensitivity: Is the user sensitive to the cost of a journey or not so much?

Environmental sensitivity: How much is the user willing to sacrifice (e.g., in terms of time or money) to choose a reduced emissions route?

Climate Goals: What is the user's current carbon footprint? How is their current carbon footprint broken down into its components? What goals do they have for reducing their carbon footprint?

Airline preferences: All else being equal, does the user have a preference as to the airline that they want to fly?

Vehicle Information: What vehicle do they own (if any)? Would the user allow for streaming of real on-board diagnostics (OBD) performance data from their vehicle to more accurately determine vehicle fuel efficiency?

Connection preferences: How long ahead of time does the user feel like they need to arrive at an airport, a train station, etc. to feel comfortable?

### Environmental Data

Loading: The number of people on a given mode of travel significantly affects the efficiency of that leg of travel. If we have access to that information from the company/organization providing the transport, that would be ideal. Getting feedback from users of the system would be good, either as a primary source or as a check on the source data.

Traffic: Traffic congestion either estimated or real time may be taken into consideration when planning for a journey's environmental impact and/or schedule impact. A car becomes much less efficient when sitting in traffic.

Transit system: Are the trains and buses currently running on time? When does the next transit option arrive? Historically how close to on time have the transit systems been.

Weather: The current and forecast weather can affect the likelihood of an accident on the roads. Current and forecast weather can affect the desirability of walking and biking. How strong are the headwinds or tailwinds for aircraft. A strong wind can make biking or walking less desirable too.

### Historical Information

Traffic: When someone is planning a trip in the future or a roundtrip, what are delays likely to be? If someone is planning a multimodal trip with a flight and then rental car to their final destination, then what is the traffic likely to be like between the airport and their final destination.

Transit system: How historically reliable are the trains and buses that are part of this itinerary. If the itinerary involves transit connections, are the connections guaranteed connections? Does one late bus jeopardize the entire schedule?

Weather: Seasonal trends can be considered to predict what may affect a flight many months out. We may avoid itineraries that travel through an area of the country with seasonal thunderstorms if those significantly increase flight delays. Similarly, changes in the jet stream can markedly impact East-West travel times. Having historical knowledge of the jet stream and its impacts to flight patterns may help us predict changes and future environmental impact.

Load Data: The number of people on a particular flight, train, or bus affects the efficiency of that mode of transportation considerably. If we can use historical data to better estimate (e.g., months in advance) how full a particular flight will be, we can better advise users to the preferred itinerary choice(s).

### Company Reports and Data

Some companies are more committed to the environment than others, and there are standardized reports that evaluate the environmental impact of companies. This information may be considered as part of the overall calculation. For example, if we know that one airline's ground operations are more energy efficient than another's, this can be used in the overall calculation.

These benefits don't have to just accrue from direct operations. A company ultimately should be responsible for all of its emissions and those overhead emissions should be assigned to a flight. For example, an airline that encourages its flight crews to live close to their home base (rather than commuting to their base using other flights) will reduce its overall emissions. This broad-based reduction in greenhouse gases (GHG) can be applied to flights on this airline.

### Public Record Data

A public transit company's operations records may be public. The amount of energy used by the transit agency may be available. If this is the case, then we may be able to more accurately evaluate the efficiency of public transit based at least in part on these public records.

The calculations for environmental impact may include the amount of greenhouse gases released by the fuel/energy used to get the transport from point A to point B divided by the number of passengers on the transport. If we are estimating the emissions from this flight prior to the journey, we would need to estimate the number of people on board the aircraft.

CO2/person=((CO2/(lb of fuel)*lbs of fuel used for flight or transport))/(number of people on flight or transport)

The inherent energy in building the transport may also be taken into account. There is an environmental cost to manufacturing a new transport and this cost may be amortized over the life of the transport. For example, the energy used to make the metal in a new aircraft may be split up over everyone who flies in that aircraft. There is a balance to buying the newest, most fuel-efficient aircraft and keeping older aircraft running longer to spread out their construction cost. We would need to estimate the aircraft's lifetime to take into account the embodied cost of its construction.

CO2/person=((CO2/(lb of fuel)*lbs of fuel used for transport))/(number of people on this transport)+ . . .

GHG released to build transport*(miles traveled by this user)/(total miles traveled over the aircraft's lifetime)

To this we can add the overhead of how much energy the company running the transport uses to maintain their business and we would divide that energy use up among all the travel legs and passengers. For example, an airline uses energy outside of the flights that it runs just to maintain its business (e.g., heating or colling its buildings). This energy may be split among all of its flight operations and assigned to its flights.

CO2/person=((CO2/(lb of fuel)*lbs of fuel used for transport))/(number of people on this transport)+ . . .

GHG released to build transport*(miles traveled by this user)/(total miles traveled over the aircraft's lifetime)+ . . .

(GHG released in annual company operations)/(number of annual users of company)

Fuel refining costs. It takes fuel to make fuel. There is a distribution loss to operating electric trains. These inefficiencies may be estimated and included in the environmental impact. The n terms below are greater than 1 and account for this inefficiency.

CO2/person=η_1((CO2/(lb of fuel)*lbs of fuel used for transport))/(number of people on this transport)+ . . .

η_2 GHG released to build transport*(miles traveled by this user)/(total miles traveled over the aircraft's lifetime)+ . . .

η_3 (GHG released in annual company operations)/(number of annual users of company)

The equations above are just one way to divide cost and we may decide to divide cost by number of users rather than miles flown or through some other ways of accounting.

At least some of the inputs described in the first section may be used to better estimate the fuel used in the transport. For example, traffic patterns may be used to estimate how different a car's fuel efficiency will be from the manufacturer's ideal highway specification.

Weather related flight delays may be based at least in part on date and historical airport congestion. Moreover, flight delays based at least on date and/or time may be used to estimate how much additional fuel may be used sitting on the tarmac or circling in the sky over and above the basic amount of fuel needed to fly straight from point A to point B.

Load estimation of the number of people expected to be on a transport based at least on time of day, day of the week, or time of year and/or holidays may be used at the time of booking, because the more people on a flight the more efficient it will be. If we can hook into an airline's reservations system and or partner with an airline to help them provide flights that are completely full, then we will be better able to offer the user better ecological and cost options.

To make the following discussion of marginal cost more readable, we will use as examples planes and flying, but the disclosed techniques are equally applicable to any sort of transport, such as trains and buses or shared rides.

There are a variety of ways of dividing the ecological cost of a flight between the passengers. For example, in one approach, the total CO2 and/or ecological impact caused by the entire flight may be divided by the number of passengers on the flight. This is an even split in which every passenger is assigned an equal ecological cost. This was described previously.

Now we will create an explicit function of the number of people flying (or being transported).

CO2(N)=CO2/(lb of fuel)*lbs of fuel used for flight or transport of N people

Another way to apportion the ecological cost of a transport is a concept called marginal cost. In this method of calculation, if N passengers are booked on a flight and an N+1th passenger books a seat, this new passenger may only be responsible for the extra bit of fuel that the plane consumes because they are on the flight. In this accounting approach, the N prior passengers are all responsible for a larger share of the ecological cost of the plane flight than subsequent passengers. This approach may be useful because a person boarding a plane that is already going to fly with or without them is only causing a relatively small amount of fuel to be consumed.

The amount of CO2 “used” in marginal accounting by the N+1th user may be expressed as

$$ΔC O 2 ( N + 1 ) = CO 2 ( N + 1 ) - CO 2 ( N ) .$$

In an extreme version of marginal cost accounting, the first person to book a seat on a flight would be responsible for the ecological cost of flying the entire plane empty plus their own weight. However, in reality, an airline would probably cancel a flight that had only one passenger and book them on a different flight. An airline would only fly a flight that is perhaps at least 20% full. Similarly, passengers who are over-booked on a particular flight won't cause the creation of a whole new flight. Instead, they will just fill up empty seats on a different route.

Because of considerations like this, useful accounting for a flight will almost certainly entail assigning an ecological cost that falls in between the two extremes of average and marginal cost.

An excellent use of marginal accounting is probably the train system, because the trains will run whether they have passengers or not. Moreover, if a train completely fills up, it is almost never the case than an entirely new train added. Possibly a new train car might be added, but not a whole new train.

If an airline is willing to partner with our booking solution, they could provide pledges on a per flight basis as to how full their flight will be on the day of travel. For example, they may promise that their flight from San Francisco International Airport to Miami International Airport will be at least 80% full. Everyone who books up to the 80% capacity will split the ecological cost of an 80% full flight evenly. Everyone who books beyond the 80% capacity mark will only be penalized for the marginal ecological cost of the flight. This would make those additional seats more desirable and would encourage users to pay more for them.

If the airline doesn't meet its pledged targets, then the airline's environmental reputation would be dinged. Users would then also consider an airline's environmental reputation when booking a flight.

Another way of balancing even cost with marginal cost is to use historical capacity data to smoothly transition between these two metrics. If we know that a flight typically flies between 50% and 80% full evenly distributed between the two ranges, then we can evenly split the ecological cost among the first half of people to fly. The last 20% of the people to fly may get to fly based at least in part on the marginal cost of their ticket. For the people who book in between 50% and the 80% mark, the ecological cost will fall in between the even split and the marginal cost. The weighting between the two could scale relative to the probability of having a load between the two. For example, if half the time the flight was less than 65% full and the other half of the time the flight was over 65% full, then the passenger at the 65th percentile loading of the plane would have an ecological cost that was halfway between an even split of all the passengers and their marginal ecological cost.

Cost is often straight-forward to calculate and present to the user, but there may be situations in which an application can help optimize how much the user pays for the journey. For example, if a user has an itinerary that involves a rideshare, a travel website site may ask whether other users can be invited to share the same rideshare, which would both reduce the cost and improve the environmental benefit.

Sometimes, users think of the operation of their car as being free, apart from the gas consumed. But cars require maintenance and insurance. The user can be presented with the cost of wear and tear for a personal trip that they are taking. This way users have a fair comparison between public transit and use of their private vehicle.

Schedule calculations can be less straight-forward than price and ecological impact. While price and ecological impact may typically have a linear impact on a user's preferences, schedule consideration may be very non-linear. For example, a user may want to arrive at their destination by a certain time and date and any itinerary that arrives later than that is useless to the user.

A user may like to have an airport layover that was close to 1.5 hours. A shorter layover might be undesirable because they would be rushing and stressed by the change of planes. A longer layover would be undesirable because of the extra time spent on the journey.

Schedules can have an amount of uncertainty built into them. Flights can be delayed, cars can be stuck in traffic, travel connections can be missed, etc., Good routing and itinerary building software will take these factors into account. The resulting uncertainty ranking may rank more-robust itineraries above otherwise equivalent itineraries. For example, a nonstop flight booked directly from San Francisco International Airport to Miami International Airport over Christmas may rank higher than one with a layover in Denver, because of the chance of a winter storm in Denver with potential delays to the itinerary.

Given a number of itineraries that all have N different characteristics (e.g., monetary cost, ecological cost, duration, and departure and arrival time), these different possibilities can be embedded in an N-dimensional space. Users are often presented with the extremes of the space along a particular axis (e.g., the itinerary with the lowest cost or the shortest duration, or the minimum ecological impact). But in viewing the travel itinerary space in N dimensions, other compromise choices may become distinct, such as an itinerary that is relatively low cost, relatively short, and ecologically cheap. The routing and booking software may not be just interested in extremes along a single axis, but may consider outliers of a cluster or a group of choices.

One way of finding a good extreme compromise point is as follows. Use a weighted metric similar to the following one for an itinerary. Other itinerary considerations could be included as additional terms:

$$w ( itinerary ) = γ\_price ( price ) \hat{} 2 + γ\_duration ( duration ) \hat{} 2 + γ\_eco ( CO 2 ) \hat{} 2$$

We are most interested in presenting to the user the minimums of the above metric as the gamma weighting factors are varied. The weighting factors in front of each of the terms could vary with the user. For example, if the user is sensitive to cost then the price weight may be larger than for a user not as sensitive to cost.

Continually varying the weighting factors and finding the minimum may winnow down a huge number of itineraries to a smaller number M that form the boundary of the cluster of choices.

It makes little sense to present a user with choices very similar to each other. So additionally, we may be interested in presenting the user with options that are distinct and far apart from each other in this N-dimensional space. We could use a metric similar to the one below to measure the separation of two options. And similar to the preceding equation, we may add additional terms for other itinerary factors.

$$d ( itineary\_ 1 , itineary\_ 2 ) = γ\_price ( price\_ 1 - price\_ 2 ) \hat{} 2 + γ\_duration ( duration\_ 1 - duration\_ 2 ) \hat{} 2 + … \\ γ\_eco ( CO 2 \_ 1 - CO 2 \_ 2 ) \hat{} 2$$

We may then ensure that the options presented had at least a minimum amount of space between them and or use the above metric to choose a set of (e.g., five) options that were maximally separated from each other. Choosing options that are widely spread in the N-dimensional space may ensure that the end user is presented with a number of options that are all different from each other and may give the user a wider set of choices that are obviously different from each other than presenting them with many highly clustered options.

If we wanted to reduce the M number of compromise choices described above to an even smaller set of P choices, we could do something similar to the following. Find the boundary Voronoi cell around each of the M compromise itineraries. If M is bigger than P, eliminate the smallest Voronoi cell and itinerary from the boundary surface. Recalculate the Voronoi surface diagram with the missing itinerary. If M is greater than P, continue eliminating a cell and recalculating the boundaries.

Having a user rank a set of very distinct options allows us to learn more information and more robust information about the user's preferences.

The website or the application may take some or all of the preceding inputs, run through the calculations described above, and display to the user a number of disparate options to help them choose their transportation modalities. These options may be described by their itinerary, duration, monetary cost, and/or their ecological cost. Additional factors could be included and displayed, such as calories burned and/or pleasantness of the journey.

Once a user picks an option, the application may book tickets, a rental car, etc. If the user chooses an option that involves ride sharing, the application or website may arrange for a pickup at the station when the train or plane arrives.

The application may also try to aggregate demand. For example, if multiple users are heading in the same direction with the same itinerary, some or all of the users could ride in a single ride-share car rather than multiple separate cars. The application could try to get users to fly on the same flights.

To the extent that users allow their data to be shared, the application or website may share aggregated data on-demand for various routes. This data may allow airlines or other transport companies to better manage their fleets.

To the extent that users let us do so, the application will have the information to give feedback to travel providers about how much users are willing to pay for an ecologically better flight. If companies are trying to improve their ecological branding and need to charge a premium to reduce the amount of CO2 released, the application or the website may provide service providers with information about how much a typical consumer is willing to spend per pound of CO2 reduced.

The application may estimate environmental impact prior to travel. After the travel has been completed, the actual ecological cost and the actual schedule of the journey will be much better known. If we can gather this data from either the user, public records, and/or the transport company, we can provide the user with a much more accurate calculation of their ecological impact. We can also enter that information into the historical database to better estimate impact in the future.

One example of such feedback is real-time flight data. If post journey, we can look at the actual route taken (including time on the ground), then we can better estimate actual ecological impact and better predict future delays and fuel consumed.

Both this information and the schedule information can go into the historical data to be used to improve the estimates for future users of the system.

We could solicit direct feedback from the user to gauge how full a particular flight was. At the same time other information can also be gathered about the overall experience. Would they use the same routing? How was the quality of their journey? Did it meet their expectations?

The most environmentally expensive thing is for an airline to add a new flight to keep up with demand. This is especially true if the newly added flight doesn't travel full. Environmentally, the best thing that can happen is for an airline to cancel a flight and aggregate customers onto other existing flights. If we monitor the addition and cancelation of flights in the flight database, and predict the conditions under which flights are added and cancelled, we can try and nudge users booking in a way such that they set up conditions for flights to be canceled. We may try to reverse engineer the schedule changes or partner with an airline to better understand their calculations.

If an airline knows which passengers are flexible flyers, they may be able to cancel a flight and reassign people to different routes. Because these people are taking up unused capacity on the other flights, they may be assigned marginal ecological cost.

Once one or two users of the application or the website have booked a particular itinerary (and even a particular flight), it behooves the application or the website, if all else is equal, to nudge or encourage new users onto that same itinerary. The more people we can get to share the same flight, the lower the environmental impact of the flight.

Similarly, if we can nudge or encourage users away from environmentally costly flights (such as regional jets), then we might be able to set up situations in which those flights are cancelled.

In order to better represent the wide range of choices that the user has, multiple values of the variables may be placed onto a scatter chart, which can have an additional color scheme. In the example shown, the y-axis represents price and the x-axis represents the duration of whichever is longest the outbound or return journey. The color indicates the pounds of CO2 released for the itinerary. A more-red color indicates higher CO2 emissions, while a more-green color indicates lower CO2 emissions. Each dot on the scatter plot indicates the characteristic of a single flight or a group of flights.

It should be clear that the colored scatterplot can be created for any set of desirable characteristics. For example, the color could indicate airline instead of environmental cost. One of the axes could represent length of layover instead of total trip duration.

The flights at the extreme values and/or a potentially good compromise flight may be highlighted and emphasized to help guide a user as to what is possible. For example, we may highlight the itinerary with the lowest carbon footprint, the cheapest itinerary, the fastest itinerary, and/or an itinerary that is a good compromise between all three. These highlighted itineraries may be emphasized on the schedule interface, which is described below.

Note that when you click on or hover over one of the dots on the scatterplot, the details for that itinerary may pop up for examination. This information may also be displayed for the schedule shown in the schedule interface, which is described below. The airlines associated with the itinerary may be highlighted in the airline interface. If you want to lock in or select a particular leg of the journey, that can be done in the pop-up information.

If the user wants to constrain themselves to itineraries of a certain price or a certain duration, they can zoom in on the plot. The zooming can be done using a touch-sensitive display (e.g., using two fingers) or with a mouse and cursor. If the user wants to ensure that their itineraries meet a certain carbon footprint, they can drag a slider on the colored range that indicates CO2 emissions and flights releasing more CO2 may either disappear or may be deemphasized.

The schedule interface may include a column for the departure city and another for the arrival city. The time of day may be indicated by the coloring (e.g., deep blue for night, yellow for day). This interface may have the advantage of showing the time difference between the two cities. A particular leg of the journey may be indicated with an arrow between the two. The base of the arrow may represent the departure time and the head of the arrow may indicate arrival time. The length of the arrow is then the length of the whole leg.

All flights currently being considered by the user may be displayed and scattered on the outbound and return schedule chart. Less desirable flights may be placed at the bottom and may be greyed out. More desirable flights may be layered on top with transparency with the most desirable flights appearing on top and being emphasized.

As with the scatterplot, you can zoom in. In this case, the user may be zooming into a particular time of day either departure time or arrival time. If you want to lock in a particular departure or arrival time, the user interface may include a toggle box. Once a user is zoomed into a particular time of day, the user can constrain their flight selection to that period, so that when they zoom out the flights presented are still constrained and all other flights disappear or are deemphasized.

The airline interface may include of many different icons with airline logos of different sizes. The size of each icon may be proportional to the number of flights by that airline available for this route. When an itinerary is selected on the scatterplot, the airline(s) responsible for that itinerary gets emphasized. When a user hovers over an airline icon, the routes and itineraries associated with that airline are emphasized. If a user clicks on an airline's icon or multiple airlines icons, it will constrain the choices to that (those) airlines and deemphasize the others.

Alternative suggestions for ground transportation or mixed-mode itineraries.

On entry into the system, the booking system may ask the user if they would like to enter in the car that they use. This information may be used to help the user understand their carbon impact and to make suggestions about alternatives.

Sometimes, especially with a large group, it is better to drive a short leg than to fly the leg. The fuel efficiency of a vehicle with many people is much higher than a regional jet.

When the system sees that there's an alternative to fly into a nearby airport and drive the remaining distance, it will suggest that as a possibility.

If it is possible for the trip to be performed in a more fuel-efficient way by using a personal car, a rental vehicle, a train or bus, the application or the website will make these suggestions.

Any of these suggestions that have radically different trip durations may not appear on the scatterplot because they would skew the scatterplot. Instead, these suggestions may appear as additional possibilities on the CO2 impact axis. By presenting these suggestions, motivated users act on the suggestions.

When presenting the details of an itinerary, the carbon impact can be indicated as the number of miles driven by an average American car or the miles you would need to drive in your own car if that information was entered. This makes the impact of the users booking choices clearer to the end user.

If the user has submitted a carbon plan or pledge, then this trip may be counted up against that so that they can see where they stand.

Some users might not be comfortable with the graphical user interface illustrated in the first embodiment. These users might prefer to interact with a search engine via a user interface that is, e.g., more text based. In order to accommodate these types of users, we envision using a user interface similar to the one shown above.

This interface shows a limited number of flights that are all distinctly different from one another, typically varying significantly in either price, duration, ecological cost, departure time, or arrival time. This allows a user to view a limited set of distinct flights that they can process, understand, and evaluate.

If you hover over an itinerary in the user interface, additional details may be shown, including flight numbers etc. If you hover over a CO2 number, a description may be provided describing how to relate to the amount of CO2 shown. For example, we could describe the amount of miles your own car would need to be driven to generate the same amount of CO2 and describe the difference between the itinerary choices similarly.

Icons may be used on the outbound and return flights to easily and quickly show a user the schedule of the itinerary. This may allow a user to easily and quickly recognize morning, midday, afternoon, evening, and/or nighttime flights. While not shown, the duration of a leg of the itinerary can be represented with the length of the arrow. This may allow the user to quickly recognize less desirable long duration itineraries.

The columns could be dragged back and forth to indicate how the user prioritizes one itinerary characteristic versus the others. For example, if the user drags the price column to the left of the CO2 column, then the user is indicating that they are more sensitive to price than to environmental impact. Similarly, the rows containing itineraries could be dragged up and down to indicate that the user prefers one choice over another choice.

Each itinerary choice would also have a way to provide more nuanced feedback. This Nuanced feedback could be provided through drop down menus that would have options that rate how much the user likes or dislikes the itinerary, and then why they like or dislike the itinerary. Here are some examples of options as to what a user thinks of the itinerary:
too expensive;
too long;
arrives too late;
departs too early;
I would prefer a different airline; and/or
I want a flight with fewer emissions.

Another way of providing choice is through simple written natural language recognition. The user would just type their thoughts on whichever itinerary options they want to, and the system would use that input to find flights that would be more appealing to them. There may be some feedback from the system to ensure that the sentence or phrase typed in matched the user's desires.

The button refine my search may use the user's feedback to provide a new set of compromise itineraries that more closely match the users desires. This process could be repeated or iterated until the user settles on a flight that they like.

The system may store or keep a list of the choices presented to the user, so that, during the search process, the user could go back and book one of those options.

A user's choices may be presented on a visual scale, so that they can see how much different choices contribute to “saving the environment.” It is important that people see the relative difference between their choices and/or the absolute savings that better choices could make.

The environmental impact could be conveyed using icons instead of a plot or graph. Icons could be a more concise and visceral way to communicate environmental impact.

Polar bear on an iceberg: We could display a polar bear on a larger or smaller iceberg to indicate the significance of the travel being booked. If a route has more environmental impact, the iceberg may shrink in size, etc.

Polar sea ice coverage: The icon could display a polar view of the world with more or less sea ice.

The disclosed techniques may show users how this particular journey relates to their overall climate goals. If a household is trying to reach lower CO2 emissions than they have released in the past, then they may be shown how this particular trip being considered impacts their overall climate footprint and any particular climate pledge and/or goal they may have set for themselves.

### Absolute Savings are Important

The disclosed techniques may allow users to know the absolute numbers and/or the relative numbers.

When savings are displayed in a relative fashion, then a flight on a highly environmentally impactful regional jet that occurs at the end of a transcontinental flight may appear less impactful than the same flight for a user just flying regionally. However, it is important to discourage both users from taking this flight if they can avoid it.

The application or website does not want a long intercontinental flight to Europe to mask significant savings that would take place by flying less within Europe once a group or travelers has arrived.

### Computational Efficiency

In some embodiments, the disclosed techniques provide improved computational efficiency. Current, state of the art travel tools estimate greenhouse-gas emissions for flying. While some websites allow users to sort flight options based on these emissions estimates, they typically do not allow the user to consider the aggregated emissions estimates for multi-modal travel, e.g., a flight and a drive. Indeed, booking websites usually do not allow for emissions comparisons between flying and personal modes of transport, such as driving a personal vehicle.

Moreover, because of the current absence of a travel website that performs multi-modal emissions estimates, an individual attempting to balance the emissions of their travel with the convenience of their journey will often expend a lot of their time and significant computing resources doing so.

Here are some representative actions and calculations that an eco-minded consumer would currently have to do to ascertain the best journey for themselves. Notably, a trip that best balances convenience, cost, and emissions.

The hypothetical user would have to look up flight options, both directly to their final destination and also to nearby airports (or from nearby airports) from which they might take another mode of transport, e.g., rail, personal vehicle, bus, or boat. They would need to not only note the emissions estimates for all these flight options, but they would need to research and understand the emissions model used to calculate these flight options.

Two examples of aspects of the flight emissions model that the hypothetical user would need to understand would be whether the model considered radiative forcing or not, and whether or not the model considered upstream emissions.

Once the user has some best guesses as to which flights to nearby airports may work, they have to start looking into the availability and timing of other modes of transport from the nearby airports to their final destination. They would need to look up bus schedules, shuttle bus schedules, rail schedules, ferry schedules, and/or driving times. For convenience, they may need to take into account the time it might take to transfer to public transit. They need to consider the time it might take to rent a car. With this information, the hypothetical user would have a sense of the convenience of alternate multi-modal itineraries.

The hypothetical user would need to add the price of the alternate modes of transportation to the cost of the flights to nearby airports. With this information, the hypothetical user would have a sense of the cost of alternate multi-modal itineraries.

However, the user still does not have enough information to make an informed decision that balances travel convenience and cost with emissions. They may now need to research the emissions of the alternate modes of travel from nearby airports. They may need to find emissions models for the forms of public transport and personal vehicle travel that were options. These models are not as simple to use as the flight emissions estimates presented during booking. The hypothetical user may have to take milage estimates from nearby airports to their final destination and run their own calculations.

Additionally, the hypothetical user may need to understand in detail these alternate emissions models, so that they could be reconciled with the flight emissions model(s). For example, do the vehicle emissions models that they are using consider upstream emissions? If there are incompatibilities between the flight emissions models and the alternate emissions models, the hypothetical user may have to adjust the emissions of either or both models to make them compatible, so that they can be combined and compared.

We now talk about some of the aspects of the emissions models that an end user would need to understand in order to be able to make a comparison.

Scientists generally agree that flying causes more planetary warming than just the greenhouse gas emissions of their engine combustion. This additional warming results from effects like the added impact of emissions in the upper atmosphere and persistent contrail cloud cover that reflects additional heat back down to the earth. Current best practice for the warming effects of flights includes a term known as radiative forcing. This is often modeled as a multiplicative term that adjusts baseline emissions. Current best estimates for this term range between 1.5 and 5 with 3 often being used. Emissions from a vehicle do not incur this added warming factor. When comparing the warming potential of a flight to that of driving, the emissions of the flight must include this radiative forcing term in order for the comparison to be roughly accurate. A hypothetical user considering alternate forms of travel would need to research Radiative Forcing understand it and apply it to the flight emissions estimates if it was not already applied. As described later in this disclosure, the model of this radiative forcing term can be dynamic.

Another aspect of the emissions model is consideration of upstream emissions. Upstream emissions are those emissions created by the extraction and refining of the fuel that powers either the aircraft, the vehicle, or that generates the electricity used by public transport. Upstream emissions are often included as a multiplicative factor and may range between 1.1 and 1.5. To be a fair emissions comparison, both the flight and alternate travel modes should either both consider or exclude upstream emissions. The hypothetical user estimating travel emissions for the various possible itineraries would need to research the emissions models, understand whether they included upstream emissions or not, and include or exclude them in a way that was compatible with the other emissions estimates.

To summarize, a traveler concerned about balancing their emissions with their convenience would need to: look up flights to many different destinations; record all of the emissions estimates of those flights; research and understand the flight emissions model being used; find alternate modes of travel to their final destination that pair conveniently with the flights; research and understand emissions models for the alternate modes of travel; estimate the emissions for those alternate modes of travel; compensate flight emissions with radiative forcing if not already included; compensate emissions estimates to ensure that all emissions estimates include upstream emissions or compensate emissions estimates to ensure that all emissions estimates do not include upstream emissions; add up emissions within each itinerary so that emissions of different itineraries can be compared; and/or compare each itinerary considering both emissions for the itinerary, the convenience, and cost.

The proposed solution of a single website that allows for comparison of flights with alternate modes of transportation and flights with multi-modal itineraries would drastically simplify the search for the hypothetical user. Doing so would significantly reduce the amount of computation required to achieve a desirable end result, and thus would reduce use of computer resources (such as processor cycles, memory, network bandwidth, etc.).

Without the proposed solution each stage, described above typically requires effort by the user and substantial additional computational effort and energy expenditure. A single multi-modal travel comparison website would be preprogrammed to ensure that the emissions calculations between flights and alternate modes that were equivalent, so that little or no additional research, modeling work and calculation would need to be done to create a fair comparison. Additionally, a website designed for multi-modal travel comparison could allow an end user to find their ideal travel compromise between emissions, schedule, and price faster, thus saving even more computational resources.

Furthermore, a multi-modal travel website can consider dynamic factors that affect emissions (some of which are described below), which would take even more and more complicated research for an end user to take into account when making a decision.

### Dynamic Flight Warming Models

As mentioned previously, the global warming that can be attributed to flying comes not just from emissions but other factors, such as contrail formation. In certain atmospheric conditions, some contrails can last a long time and have outsize immediate warming impacts. These impacts are in addition to the CO2 greenhouse gas warming affects caused by burning fuel.

Notably, it may add only a small amount of extra fuel consumption (e.g., 0.11%) to avoid flying through the atmospheric conditions that create long lasting contrails. Doing so would avoid significant non-CO2 warming effects that are immediate.

The radiative forcing models being used for flight contribution to warming can take this effect into account either ahead of time predictively/probabilistically or post facto by looking at the actual route a flight took and either the atmospheric conditions at the time or whether contrails actually formed or not. The factors that could go into a predictive contrail estimation may be as follows: whether or not the airline flown uses a flight plans that mitigate contrails; typical flight paths for flights between the cities of interest; and how likely those typical paths intersect with atmospheric conditions that make persistent contrails more likely.

Another example of dynamic factors that could affect travel warming estimates are jet stream trajectory and velocity. Flight plans often take advantage of the jet stream when flying East which boosts their speed, thereby allowing them to use less fuel. In contrast, when going West, flight plans will typically avoid the jet stream. If the jet stream has seasonal patterns that are likely to affect certain routes, these can be probabilistically estimated.

Another example of a dynamic factor that could affect warming estimates is extreme weather, such as summer thunderstorm activity. Aircraft will often avoid bad weather events by flying around them. This increases the time in air and the amount of fuel burned. A travel website could use historical information about flight paths during different weather seasons to probabilistically estimate the likelihood that a light would need to divert its ideal path and increase its emissions.

### We Now Describe an Example Calculation for a Hypothetical Traveler

A traveler wants to go from San Francisco to Victoria, British Columbia. They search flights on a website that estimates emissions using a model that includes upstream emissions, but does not include radiative forcing.

There are no direct flights. One potential itinerary via air is to fly with one stop through Vancouver on Airline A. The travel website estimates the total emissions of the two travel legs as 120 kg of carbon.

Airline B offers a second itinerary with one stop and a longer layover, but with lower estimated emissions of 110 kg. Furthermore, Airline B pledges to avoid generating contrails.

After some additional research, the user determines a third potential itinerary may be to fly only the first leg from SFO to Vancouver using Airline B, but then take a shuttle bus from Vancouver to Victoria. The estimate for the emissions of the first leg flight may be 85 kg.

To compare the three above itineraries, they would need to remove the upstream emissions from the all the estimates, then multiply the direct emissions by the radiative forcing factor, and add back in the upstream emissions estimates. This procedure is needed because the radiative forcing component should not multiply emissions generated by extraction.

For the purposes of this example assume that the upstream emissions factor is estimated as 1.1. Moreover, assume that a typical radiative forcing factor may be 3.

Then, the total warming potential for the first itinerary may be calculated as: 120 kg/(1.1·3)+120 kg·(1−1/1.1)=327 kg+11 kg=338 kg.

In order to calculate the Radiative Forcing factor for airline B, note that removing contrails entirely changes the multiplicative factor of Radiative Forcing from 3 to 2.5. But perhaps airline B does not have a perfect track record of preventing the formation of contrails. Taking this probability into account turns the 2.5 multiplicative factor into 2.7. Using this factor, the second itinerary has a warming potential of 110 kg/(1.1·2.7)+110 kg·(1−1/1.1)=270 kg+10 kg=280 kg warming potential.

We use the same factor for the third itinerary, giving its warming potential as 85 kg/(1.1·2.7)+85 kg·(1−1/1.1)=209 kg+8 kg=217 kg of warming potential.

In this example, the hypothetical user would then need to understand the emissions of the shuttle bus from Vancouver to Victoria, which involves a ferry ride too. They estimate the bus travel of 69 km to emit 2 kg per passenger and the ferry travel of 46 km to emit 10 kg per passenger. This totals 12 kg of additional carbon for the alternate transport.

However, these calculations do not yet include upstream emissions and so to be fairly added to the flight emissions must be multiplied by a factor, which in this example is estimated to be 1.2. The total emissions for the alternate transport then becomes 12 kg·1.2=14 kg of warming potential.

These compensated emissions now get added to create the total emissions of the third itinerary of 231 kg.

After doing all the research described, and running the calculations described, the fair emissions comparison between the three itineraries would be 338 kg for the first itinerary, 280 kg for the second itinerary, and 231 kg for the third itinerary. With these numbers in hand, the hypothetical user can now compare the convenience, cost and emissions of the three itineraries.

The above example described is actually relatively simple with only three options. In real life, the hypothetical traveler may typically be faced with many more choices and significant uncertainty as to which options they should calculate the emissions of. The travel website described would have much of this information precomputed and could lead the user more quickly to a final desirable outcome than the procedure described above. The travel website would use much less computation resources and energy than a user running all the research and calculations on their own. Additionally, the travel website could more easily take into account dynamic factors (such as those described above) to make the emissions estimates more accurate.

### Implementation Approaches

The disclosed techniques may be implemented in a variety of ways, including: using a client-server architecture, an installed standalone application on an electronic device, via a Web Browser, etc. For example, some operations may be performed locally, while others may be performed remotely. Therefore, the disclosed techniques may be implemented in a centralized and/or a distributed manner. In some embodiments, the disclosed techniques are implemented using hardware and/or software, and may involve communication and accessing data from other computer systems (such as from an airline, a travel agent, etc.).

Moreover, the disclosed analysis may be performed in a variety of ways. In some embodiments, the difference factors may be used as inputs to a pretrained predictive model (such as a pretrained neural network), which may output a set of one or more itineraries and/or transportation modalities, along with their associated environmental impacts, travel time, cost, etc.

In general, the disclosed techniques may include fewer or additional operations, two or more operations may be combined, an operation may be separated into two operations, and/or there may be different operations.

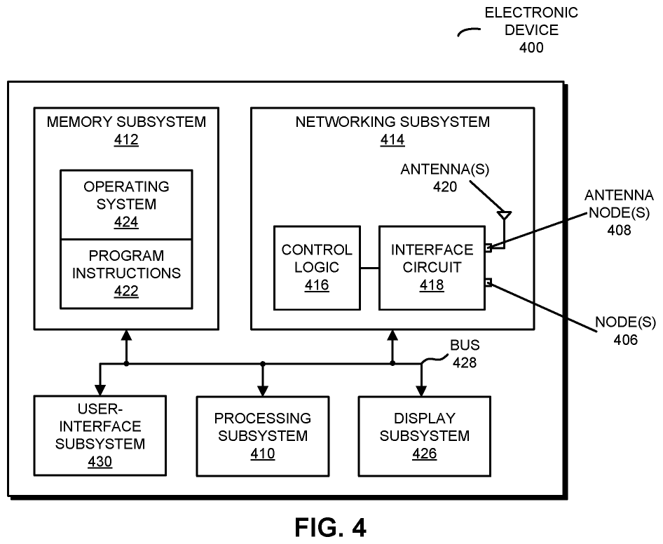

We now describe embodiments of an electronic device, which may perform at least some of the operations in the recommendation techniques. FIG. 4 presents a block diagram illustrating an example of an electronic device 400, e.g., one of electronic devices 110, access points 116, radio node 118, switch 128, a computer or server in computer system 130, and/or computer system 132, in accordance with some embodiments. For example, electronic device 400 may include: processing subsystem 410, memory subsystem 412, and networking subsystem 414. Processing subsystem 410 includes one or more devices configured to perform computational operations. For example, processing subsystem 410 can include one or more microprocessors, ASICs, microcontrollers, programmable-logic devices, GPUs and/or one or more DSPs. Note that a given component in processing subsystem 410 are sometimes referred to as a ‘computation device’.

Memory subsystem 412 includes one or more devices for storing data and/or instructions for processing subsystem 410 and networking subsystem 414. For example, memory subsystem 412 can include dynamic random access memory (DRAM), static random access memory (SRAM), and/or other types of memory. In some embodiments, instructions for processing subsystem 410 in memory subsystem 412 include: program instructions or sets of instructions (such as program instructions 422 or operating system 424), which may be executed by processing subsystem 410. Note that the one or more computer programs or program instructions may constitute a computer-program mechanism. Moreover, instructions in the various program instructions in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to a memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418 and one or more antennas 420 (or antenna elements). (While FIG. 4 includes one or more antennas 420, in some embodiments electronic device 400 includes one or more nodes, such as antenna nodes 408, e.g., a metal pad or a connector, which can be coupled to the one or more antennas 420, or nodes 406, which can be coupled to a wired or optical connection or link. Thus, electronic device 400 may or may not include the one or more antennas 420. Note that the one or more nodes 406 and/or antenna nodes 408 may constitute input(s) to and/or output(s) from electronic device 400.) For example, networking subsystem 414 can include a Bluetooth™ networking system, a cellular networking system (e.g., a 3G/4G/5G network such as UMTS, LTE, etc.), a USB networking system, a networking system based on the standards described in IEEE 802.4 (e.g., a Wi-Fi® networking system), an Ethernet networking system, and/or another networking system.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between electronic devices does not yet exist. Therefore, electronic device 400 may use the mechanisms in networking subsystem 414 for performing simple wireless communication between electronic devices, e.g., transmitting advertising or beacon frames and/or scanning for advertising frames transmitted by other electronic devices.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes a display subsystem 426 for displaying information on a display, which may include a display driver and the display, such as a liquid-crystal display, a multi-touch touchscreen, etc. Moreover, electronic device 400 may include a user-interface subsystem 430, such as: a mouse, a keyboard, a trackpad, a stylus, a voice-recognition interface, and/or another human-machine interface.

Electronic device 400 can be (or can be included in) any electronic device with at least one network interface. For example, electronic device 400 can be (or can be included in): a desktop computer, a laptop computer, a subnotebook/netbook, a server, a supercomputer, a tablet computer, a smartphone, a smartwatch, a cellular telephone, a consumer-electronic device, a portable computing device, communication equipment, and/or another electronic device.

Although specific components are used to describe electronic device 400, in alternative embodiments, different components and/or subsystems may be present in electronic device 400. For example, electronic device 400 may include one or more additional processing subsystems, memory subsystems, networking subsystems, and/or display subsystems. Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments some or all of a given subsystem or component can be integrated into one or more of the other subsystems or component(s) in electronic device 400. For example, in some embodiments program instructions 422 are included in operating system 424 and/or control logic 416 is included in interface circuit 418.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 414 and/or electronic device 400. The integrated circuit may include hardware and/or software mechanisms that are used for transmitting signals from electronic device 400 and receiving signals at electronic device 400 from other electronic devices. Aside from the mechanisms herein described, radios are generally known in the art and hence are not described in detail. In general, networking subsystem 414 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the recommendation techniques may be implemented using program instructions 422, operating system 424 (such as a driver for interface circuit 418) or in firmware in interface circuit 418. Thus, the recommendation techniques may be implemented at runtime of program instructions 422. Alternatively or additionally, at least some of the operations in the recommendation techniques may be implemented in a physical layer, such as hardware in interface circuit 418.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the recommendation techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit;
a processor coupled to the interface circuit; and
memory, coupled to the processor, storing program instructions, wherein, when executed by the processor, the program instructions cause the electronic device to perform operations comprising:
obtaining itinerary information associated with an individual;
determining environmental factors associated with the itinerary information;
dynamically computing carbon footprints of multiple types of transportation based at least in part on the itinerary information and the environmental factors; and
providing recommendation information comprising the multiple types of transportation and the computed associated carbon footprints.

2. The electronic device of claim 1, wherein the electronic device comprises a computer system and the obtaining comprises receiving the itinerary information from a second electronic device and the providing comprises providing the recommendation information addressed to a third electronic device.

3. The electronic device of claim 2, wherein the second electronic device and the third electronic device are different.

4. The electronic device of claim 1, wherein the itinerary information comprises a departure location and a destination location.

5. The electronic device of claim 1, wherein the itinerary information comprises a number of travelers.

6. The electronic device of claim 1, wherein the itinerary information comprises a desired priority for completing at least a portion of an itinerary specified by the itinerary information.

7. The electronic device of claim 1, wherein the multiple types of transportation comprise different types of transportation vehicles.

8. The electronic device of claim 7, wherein the different types of transportation vehicles comprise two or more of: an airplane, an automobile, a type of mass transit, or a bicycle.

9. The electronic device of claim 1, wherein the environmental factors comprise: available capacity on a given type of transportation, weather conditions along at least a portion of an itinerary specified by the itinerary information, or traffic conditions along at least a second portion of the itinerary.

10. The electronic device of claim 1, wherein the multiple types of transportation comprise an airplane and the weather conditions comprise a path and a strength of a wind at an altitude of the airplane along at least a portion of the itinerary.

11. The electronic device of claim 1, wherein the environmental factors comprise financial costs or incentives associated with one or more of the multiple types of transportation.

12. The electronic device of claim 1, wherein a given carbon footprint of a given type of transportation comprises an incremental carbon footprint associated with the individual and a total carbon footprint of the given type of transportation.

13. A non-transitory computer-readable storage medium for use in conjunction with an electronic device, the computer-readable storage medium storing program instructions that, when executed by the electronic device, causes the electronic device to perform operations comprising:
obtaining itinerary information associated with an individual;
determining environmental factors associated with the itinerary information;
dynamically computing carbon footprints of multiple types of transportation based at least in part on the itinerary information and the environmental factors; and
providing recommendation information comprising the multiple types of transportation and the computed associated carbon footprints.

14. The non-transitory computer-readable storage medium of claim 13, wherein the multiple types of transportation comprise different types of transportation vehicles.

15. The non-transitory computer-readable storage medium of claim 13, wherein a given carbon footprint of a given type of transportation comprises an incremental carbon footprint associated with the individual and a total carbon footprint of the given type of transportation.

16. A method for providing recommendation information, comprising:
by an electronic device:
obtaining itinerary information associated with an individual;
determining environmental factors associated with the itinerary information;
dynamically computing carbon footprints of multiple types of transportation based at least in part on the itinerary information and the environmental factors; and
providing the recommendation information comprising the multiple types of transportation and the computed associated carbon footprints.

17. The method of claim 16, wherein the multiple types of transportation comprise different types of transportation vehicles.

18. The method of claim 17, wherein the different types of transportation vehicles comprise two or more of: an airplane, an automobile, a type of mass transit, or a bicycle.

19. The method of claim 16, wherein the environmental factors comprise: available capacity on a given type of transportation, weather conditions along at least a portion of an itinerary specified by the itinerary information, or traffic conditions along at least a second portion of the itinerary.

20. The method of claim 16, wherein a given carbon footprint of a given type of transportation comprises an incremental carbon footprint associated with the individual and a total carbon footprint of the given type of transportation.
